(19) United States
(12) Patent Application Publication
(10) Pub. No.: US 2019/0210242 A1
(43) Pub. Date: Jul. 11, 2019

(54) SAW CHAIN FOR THE CUTTING DEVICE OF A TREE-HANDLING DEVICE, A TREE-HANDLING DEVICE, A SAW-CHAIN BLANK, AND A METHOD FOR ARRANGING THE CUTTING OPERATION OF A TREE-HANDLING DEVICE

(71) Applicant: Lauri KETONEN, Kristiinankaupunki (FI)

(72) Inventor: Lauri KETONEN, Kristiinankaupunki (FI)

(21) Appl. No.: 16/327,250

(22) PCT Filed: Aug. 24, 2017
(86) PCT No.: PCT/FI2017/050596

§ 371 Date: Feb. 21, 2019

Related U.S. Application Data
(63) Continuation of application No. 15/249,850, filed on Aug. 29, 2016, now abandoned.

(30) Foreign Application Priority Data
Aug. 24, 2016 (FI) U20164171
Feb. 22, 2017 (FI) 20175163

(51) Int. Cl. B27B 33/14; B27B 17/02; A01G 23/083; A01G 23/091

(52) U.S. Cl. CPC B27B 33/142; B27B 17/02; B27B 33/141; A01G 23/091; B27B 33/14; A01G 23/083

(57) ABSTRACT

A saw chain for a cutting device of a tree-handling device, which saw chain comprises links connected to each other by connector elements, in such a way that the saw chain is an endless loop, which can be arranged to circulate in a groove arranged in a guide bar. The links, include tooth links and drive links. The tooth links comprise a cutting tooth which has a cutting edge. In front of the cutting tooth is an empty space up to the next tooth link. The invention also relates to a tree-handling device, a saw-chain blank, and a method for arranging the cutting operation of a tree-handling device.

### CROSS-REFERENCE TO RELATED APPLICATIONS

This application is a U.S. National Stage of International Patent Application No. PCT/FI2017/050596 filed on Aug. 24, 2017, which claims benefit of Finland Patent Application No. FI 20175163 filed on Feb. 22, 2017, Finland Utility Model Application No. FI U20164171 filed on Aug. 24, 2016 and U.S. patent application Ser. No. 15/249,850 filed on Aug. 29, 2016.

### FIELD OF THE INVENTION

The invention relates to a saw chain for the cutting device of a tree-handling device. In addition, the invention also relates to a tree-handling device, a saw-chain blank, and a method for arranging the cutting operation of a tree-handling device.

### BACKGROUND OF THE INVENTION

The chain saw according to the invention is also used in other mechanical tree handling besides harvesters, for example, in wood-chopping machines.

The chain saw has become established as the cutting device, for example in felling machines making logs for sawmills. In practice, disc saws are also used, but they have the drawback of a great weight and space requirement. Sufficiently rapid cutting is achieved with both of these devices. Therefore splitting, which reduces the quality of sawn goods cannot occur during with cutting.

So-called guillotine cutting can also be used with small trees, mainly for energy use. Though energy trees can also be cut using a chain saw, a chain saw is liable to malfunction when used for this purpose.

However, a chain saw has significant safety problems. One of these is the possible breaking of the chain. The high speed of the chain when cutting causes parts of it to be thrown around if it breaks. For this reason the cabs of felling machines must be equipped with windshields as much as 25-30-mm thick. Such a special windshield increases the price of a multi-process machine. Despite this, parts of the chain nevertheless sometimes penetrate the glass, leading even to fatalities. Doubling the speed of the chain quadruples the kinetic energy of the parts.

A conventional saw chain has, as parts, a drive link, a tooth link, and an intermediate link. The intermediate link can also be called a side link. The tooth link includes a cutting edge and also a so-called depth-adjustment tooth. The cutting depth of the cutting edge is adjusted using the adjustment tooth. The saw chain 10 runs in a groove arranged in a rotatable guide bar (i.e. blade flange). The saw chain is driven by a drive wheel and the guide bar includes a sprocket arranged at its end for the saw chain. To perform sawing, the guide bar is, in turn, rotated relative to a pivot point arranged for it. The rotation, which can also be called, when in one direction, pressing the guide bar down, and in the opposite direction, lifting it up, takes place, for example, using a hydraulic cylinder.

In known chain saws, when sawing starts, a twig or branch can be located in the saw chain top of an intermediate link formed by side plates between the tooth links. Such a situation can arise very typically even during felling sawing. Even if the tree being felled is of a large diameter, there can often be branches in its butt area. In addition the branches can be very hard. Before the saw chain starts moving, such a branch or twig can occur at an intermediate link of the saw chain.

In the sawing event, the saw chain must bring all of the wood chips cut from the tree out of the sawing gap. If this does not take place smoothly, the sawing slows.

When the saw chain starts to move, the depth-adjustment tooth sinks partly into the tree and the cutting depth of the cutting edge can be as much as the full height of the cutting edge. This can cause the saw chain to break.

Yet another problem relating to saw chains known from the prior art, is their stretching. The saw chain should be tightened from time to time, so that it will remain on top of the guide bar. Although automatic blade tensioners are also known, they have a relatively large effect on the price of the felling head.

In conventional saw chains, there is an adjustment tooth at wide intervals in the connected tooth links, the purpose of which is to prevent the chain from biting too deeply.

### SUMMARY OF THE INVENTION

The present invention is intended to create a saw chain for the cutting device of a tree-handling device, which has improved durability and usability properties. The invention is also intended to create a tree-handling device and a saw-chain blank.

In addition, the invention is intended to create a method for arranging the cutting operation of a tree-handling device, which improves the durability of the saw chain and reduces the power consumption of the cutting device.

Several tooth links are fitted consecutively to the saw chain according to the invention, and in each there is empty space in front of the cutting edge, i.e. there is no adjustment tooth or it is greatly reduced in size. In this case, the cutting edge is prevented from biting too deeply into the wood by the fact that the cutting teeth are now so close to each other that the biting deeply into the wood of the cutting edge of an individual tooth link is naturally diminished.

In front of each cutting tooth, there is empty space until the next tooth link of 50-100% of the height of the cutting tooth, so that the height of a possible adjustment tooth is 0-50%, preferably 0-20% of the height of the cutting tooth.

In a harvester or other machine, rapid adjustment of the rotation of the saw is preferably used, which prevents completely the saw from possibly biting too deeply. In one embodiment, the response time is less than 100 ms, preferably less than 20 ms (5-30 ms). This succeeds using, for example, the saw pressing arrangement according to U.S. Pat. No. 9,669,562 B2, in which there is a simple, but effective adjustment. The power of the saw motor can be significantly low, as much as less than 50% of that of harvesters of a similar size that achieve the same sawing effect. The adjustment can be implemented using a rapid electronic adjustment, which is equipped with one or more sensors to detect the parameters of the saw, such as its rotational velocity.

As there is no adjustment tooth, there is also no need to sharpen it, thus eliminating one work stage. As there is more empty space in front of the cutting edge, sharpening can take place using larger machines and industrial methods.

With the aid of the invention, the durability of the saw chain during timber cutting is improved and thus the breaking of the chain is prevented. In addition, this can increase the saw chain's cutting effect. Further, in this way the thickness of the windshield of a multi-process machine can be reduced, which in turn reduces the related investment costs.

By means of the invention, the tree being cut no longer so easily reaches the base of the cutting teeth of the saw chain, i.e. the level of the outer edge of the side plates, as happens in saw chains known from the prior art implemented with widely-spaced tooth links. This avoids loading peaks acting on the saw chain. In addition, the saw chain stays better in the groove arranged for it in the guide bar (i.e., on “top” of the guide bar).

With the aid of the invention, the saw chain's cutting capacity is almost roughly doubled. As the saw chain's cutting capacity is greater, the speed of the saw chain can, for its part, be reduced. Despite the reduction in chain speed, a cutting speed close to the former one is maintained, but the kinetic energy of the chain drops considerably. The reduction in speed is followed in turn by a saving in the energy consumption and the energy-production requirements of the work machine.

The consecutive tooth links of the saw chain can alternate in cutting direction, i.e. can be in opposite directions. They then cut the tree from alternating opposite sides relative to a plane defined by the guide bar and also to the sawing groove. When the tooth links are more closely spaced in the saw chain, the saw chain can surprisingly be narrowed. Removing the adjustment teeth allows the saw chain to be made lower. These also result in a further reduction in the power requirement in the cutting device and thus a saving in energy. The durability of the saw chain also improves.

When applying the saw chain according to the invention in the cutting device of a tree-handling device, the rotation of the guide bar, i.e. the pressing of the guide bar against the tree being cut and the return of it by rotation, can be implemented, for example, in such a way as to take into account the current rotational velocity of the saw chain. Other addition advantages of the invention are stated in the description portion and its characteristic features in the accompanying Claims.

### BRIEF DESCRIPTION OF THE DRAWINGS

The Invention, which is not Restricted to the Embodiments Presented in the Following, is Described in Greater Detail with Reference to the Accompanying Figures, in which

FIG. 1 shows schematically one example of a multi-process machine, seen at an angle from in front,

FIG. 2 shows schematically an example of one tree-handling device, which includes a cutting device equipped with a saw chain, and which is used in the embodiment of FIG. 1,

FIG. 3a shows a side view of an example of the saw chain according to the invention in connection with the guide bar,

FIG. 3b shows a side view of the saw chain according to FIG. 3a and the tree intended to be cut in connection with the saw chain when starting cutting,

FIG. 4 shows a top view of the saw chain or blade-chain blank according to the invention,

FIG. 5 shows a schematic diagram of the hydraulic arrangement according to the invention,

FIG. 6 shows schematically the electronic adjustment in the control of the saw, and

FIG. 7 shows the sharpening of the saw chain using a shows the sharpening of the saw chain using a large grinding disc.

### DETAILED DESCRIPTION OF THE INVENTION

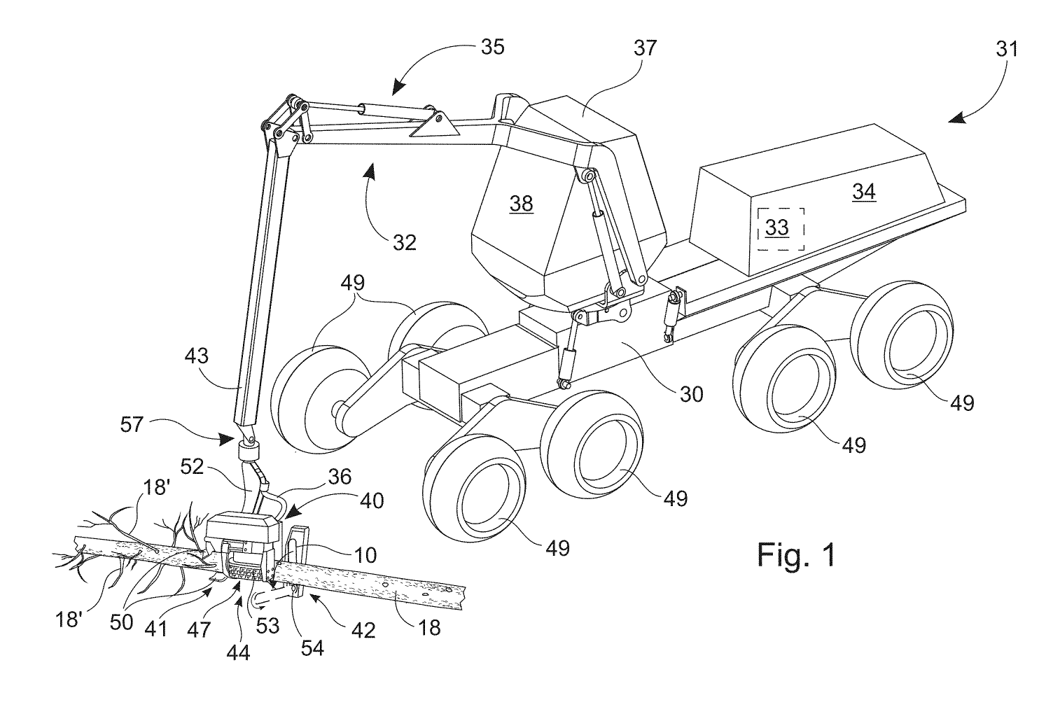

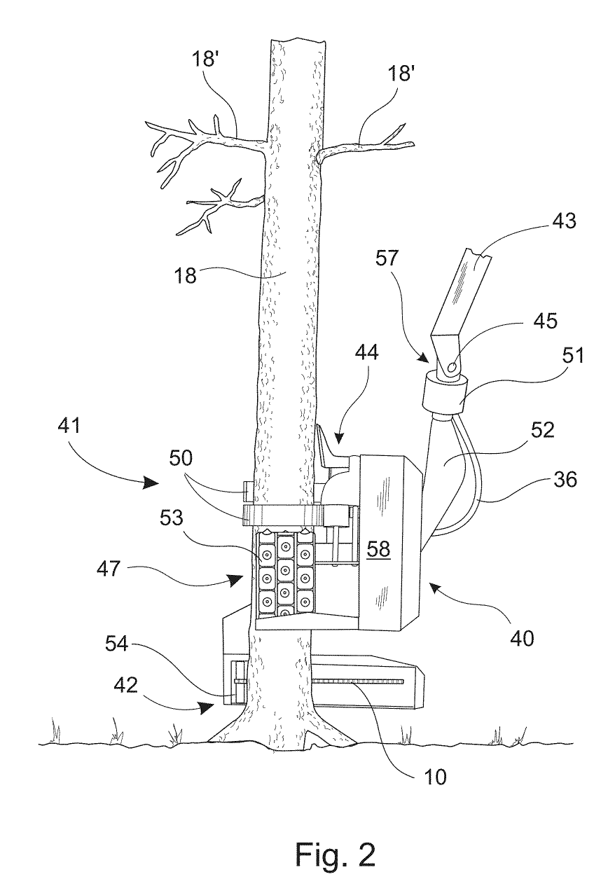

FIG. 1 shows schematically one example of a multi-process machine 31 seen at an angle from in front and in FIG. 2 from a side. In multi-process machines 31, there is usually a crane 32, fitted on a base machine 30, with a moving set of working booms 35, at the end of the last boom of which, i.e. in this case boom 43, a tree-handling device 40 is attached, for example in a pivoted manner. The pivoting of the tree-handling device 40 to the boom 43 can be made, for example, according to the prior art using two transverse rotational pivots in different directions to each other, more generally using a pivoted joint. This can also be referred to as suspension 57.

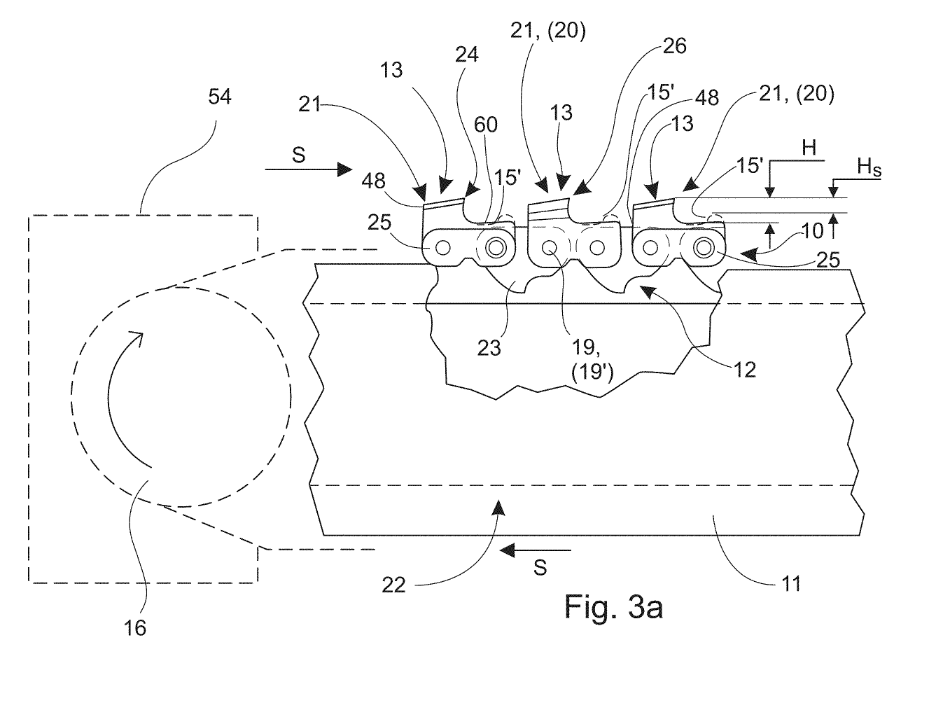

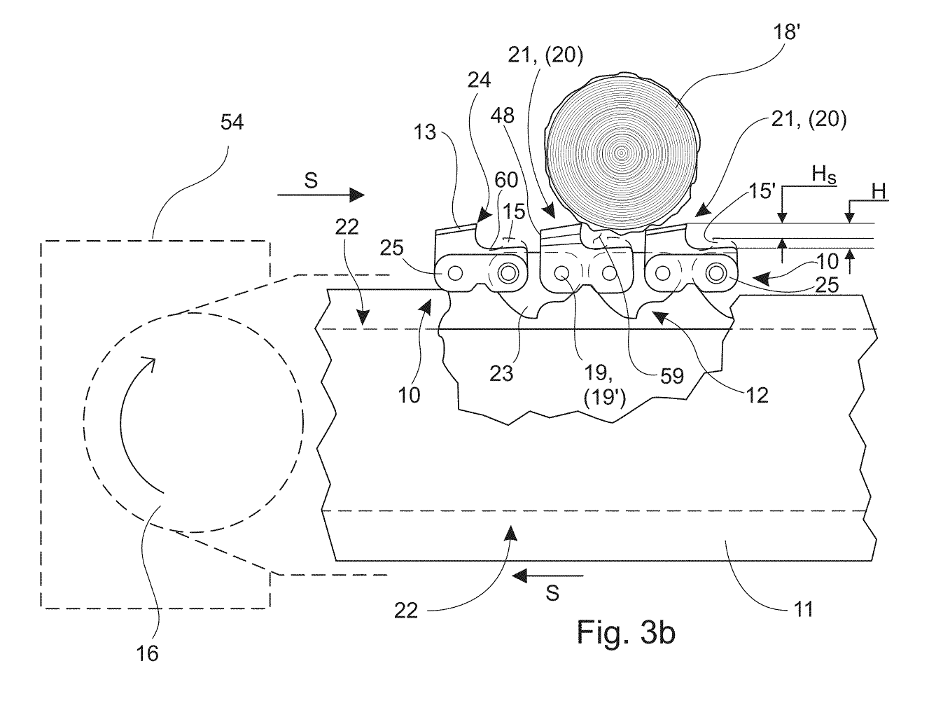

Between the tree-handling device 40 and the pivoted joint there can be a rotation device 51, which is also generally referred to as a rotator. With the aid of the rotation device 51, the tree-handling device 40 can be rotated without limit around the axis of rotation of the rotation device 51. The flow of pressure-medium required by the operating devices (for example, the saw motor 54) of the tree-handling device 40 can be brought through the working booms 35 of the crane 32 with the aid of the hoses 36, more generally, pressure-medium lines from the pressure-medium pump 33 of the base machine 30. In order to create pressure, the pressure-medium pump 33 is run, for example, with the aid of the engine 34 of the base machine 30. The motorized base machine 30 includes a cab 37, which is equipped with a windshield 38. In the cab 37, there is a seat for the driver 39 of the multi-process machine 31, who controls, for example, the crane 32 and the tree-handling device 40, more generally the operation of the multi-process machine 31. When working, the distance of the tree-handling device 40 from the cab 37 and the driver in it can be several meters, even as much as ten meters. Thus the length of the set of working booms 35 is several meters. It is then impossible for the driver 39 to see the sawing line of the object to be cut, which is made still more difficult by the rotating guide bar. The harvester 31 is equipped with, for example, wheels 49 or crawler tracks arranged to circulate around them (not shown) and sufficient ground clearance. By means of the wheels 49 and/or the crawler tracks and the ground clearance, the harvester 31 is able to move off-road. The tree-handling device 40 can be said to include an operating unit 44, in which the basic component is a cutting device 42, a feed device 47, and stripping blades acting as grab claws 50. Their operation is described in greater detail hereinafter with reference to FIG. 3.

FIG. 2 shows a rough schematic diagram of one example of the tree-handling device 40 used in FIG. 1 seen from the side in the position in which a tree 18 is begun to be felled. In connection with the invention, the tree-handling device 40 can be understood very widely. A very typical series of processing operations, which are performed using the tree-handling device 40, is the standing felling of the tree 18, the stripping of the branches 18′, and the cutting of the stripped trunk into parts of regular length as the stripping progresses. Similarly, the processing performed by the tree-handling device 40 can also be the individual operations referred to above or various combinations of them. It can be, for example, stripping of tree trunks, cutting performed in connection with stripping, and/or collection of one or more ready stripped tree trunks, for example, for the stacking or loading of the trees. One or even more trees may be handled at a time, in which case it can be called the bundle handling of trees.

To rotate the operating unit 44, the tree-handling device 40 includes an operating device for rotating the operating unit 44 between the felling position and the stripping positions. In FIG. 2, the tree-handling device 40 is in the felling position. The operating unit 44 is then mainly vertical. The stripping position is achieved when the operating unit 44 is rotated by the operating device by about 90° from the position shown in FIG. 2. As a result of the rotation, the operating unit 44 is mainly horizontal, as shown in FIG. 1. The operating device for rotating the operating unit 44 can be, for example, a hydraulic cylinder located in the casing 58, but it can also be some other operating device suitable for the purpose.

The tree-handling device 40 also includes a cutting device 42. The cutting device 42 is now a rotating blade-chain saw. It is located at the end of the tree-handling device 40 and thus also of the operating unit 44. The felling of the tree 18, i.e. felling cutting, can be performed using the cutting device 42 and, in addition, also the cutting of the tree 18 into regular lengths. In addition to the saw chain 10, the cutting device 42 also includes a rotating guide bar 11 (FIGS. 3a and 3b), a saw-chain 10 drive wheel 16 (FIGS. 3a and 3b), by which the saw chain 10 is rotated around the guide bar 11, and guide bar 11 rotation means for performing sawing. Using the rotation means, the guide bar is pressed, i.e. loaded against the tree 18 being sawed. In addition, the rotation means also return the guide bar 11 with the saw chain 10 back to its home position for the next sawing. FIG. 1 shows the extreme positions of the guide bar 11 and an arrow showing the back-and-forwards rotational movement between them of the guide bar 11.

In principle, the tree-handling device 40 operates by gripping the tree 18 with the gripping means 41 of the operating unit 44. An example of the gripping means 41 are the opening and closing grab claws 50. The grab claws 50 can also have a blade function for stripping the tree 18 of branches 18′. The feed device 47 can also act as the gripping means. The feed device 47 can be, for example, rollers, crawler tracks 53, or even a pulsed feed. Instead processing an individual tree 18, the gripping means 41 and/or the feed device 47 can also be used to perform the bundle processing of trees.

Once the standing cutting of the tree 18 has been performed using the cutting device 42, the operating unit 44 is turned to the horizontal position to strip the tree 18 of branches 18′ and cut it into parts of regular length. After that, the tree-handling device 40 is moved relative to the tree 18 by the crawler tracks 53 of the feed device 47. As a result, the tree 18 travels through the operating unit 44. When the grab claws 50 are closed they are tightly against the trunk of the tree 18 and at the same time as the tree 18 moves relative to the operating unit 44 the stripping blades in the edges of the grab claws 50 cut the branches 18′ off the tree 18. When a part of the desired length of the tree 18 has been stripped, the trunk is sawn into a regular-length part with saw chain 10 of the cutting device 42. After this, stripping continues by feeding the tree through the grab claws 50.

FIG. 3a shows a side view of one example of the saw chain 10 according to the invention on a guide bar 11. Correspondingly, FIG. 3b shows a side view of the same saw chain 10 when the saw chain 10 is in contact with the tree 18 to be cut, when cutting begins. The saw chain 10 is thus intended, for example, for the cutting device 42 of the tree-handling device 40 shown in FIG. 2. The saw chain 10 includes links 20, which are connected to each other by connector elements 19′. Here the connector elements 19′ are rivets 19. In the saw chain 10, the links 20 are connected to each other by rivets 19 in such a way that the saw chain 10 is an endless chain loop, which can be fitted to rotate in a groove 22 arranged in the outer edge of the guide bar 11. Thus the links 20 are rotatably pivoted to each other through the rivets 19, to permit the forward and backward movement of the saw chain 10 around the elongated guide bar 11. The guide bar 11 can be an elongated blade flange, which can also be called a cutting flange or blade plate. In an as such known manner the groove 22 is on the outer edge of the guide bar 11, in the upper edge and correspondingly also in the lower edge. The saw chain 10, which is formed as an endless chain loop, can be said to have an inner circumference and an outer circumference. On the side of the inner circumference, the chain loop formed by the saw chain 10 is arranged to rotate in the groove 22 arranged in the guide bar 11. Correspondingly, the outer circumference of the saw chain 10 is to be arranged against the tree 18 for its cutting, i.e. sawing. The saw chain's 10 cutting elements are on the outer edge of the saw chain 10.

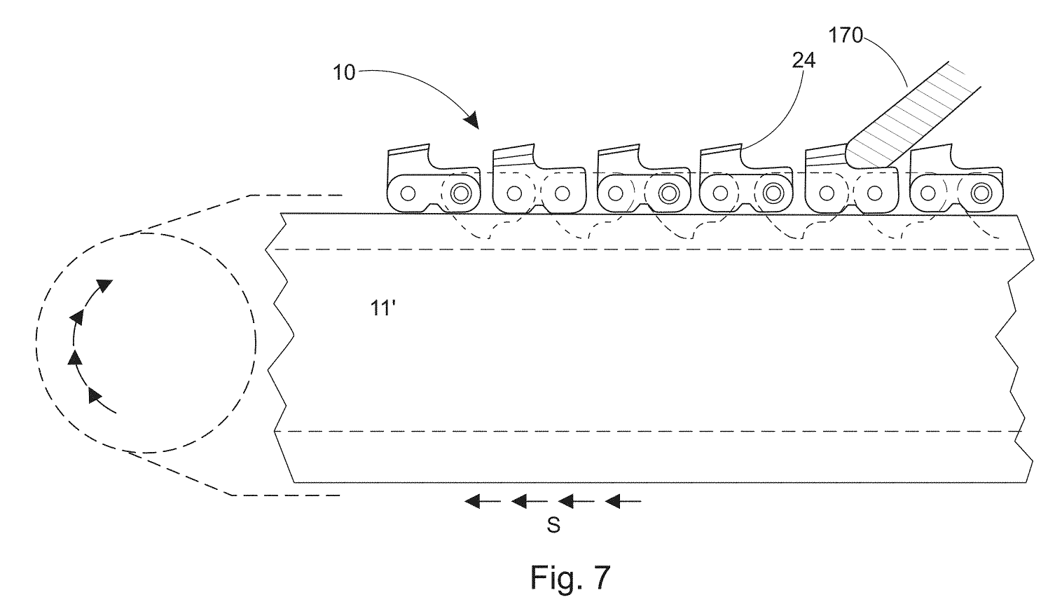

As links 20, the saw chain 10 includes tooth links 21 and drive links 12. Each tooth link 21 is formed of a cutting tooth 13 protruding sideways from one side of the outer circumference of the saw chain 10, and a side plate 25. The cutting tooth 13 for its part includes a low adjustment tooth 15 and a cutting edge 24, fitted to one side of the saw chain 10. In the endless chain loop formed by the saw chain 10 this side is outside the saw chain 10. In the opposite direction relative to the direction of rotation S of the saw chain 10 there is first in the tooth link 21 an optional depth-adjustment tooth 15, which can also be called a depth or adjustment tooth. In FIG. 3a, the depth-adjustment tooth 15′ is shaped in such a way that a large sharpening disc (FIG. 7) fits into the space. It can be a blunt protrusion made in an as such known manner in the cutting tooth 13, but here has a height of only 0-50%, preferably 0-20% of the height H of a cutting tooth 13. The depth-adjustment tooth 15 adjusts, in an as such known manner, the cutting depth Hs of the cutting edge 24 following the adjustment tooth 15, in the opposite direction to the direction of rotation S of the saw chain 10, if the adjustment tooth is regarded as being at all necessary.

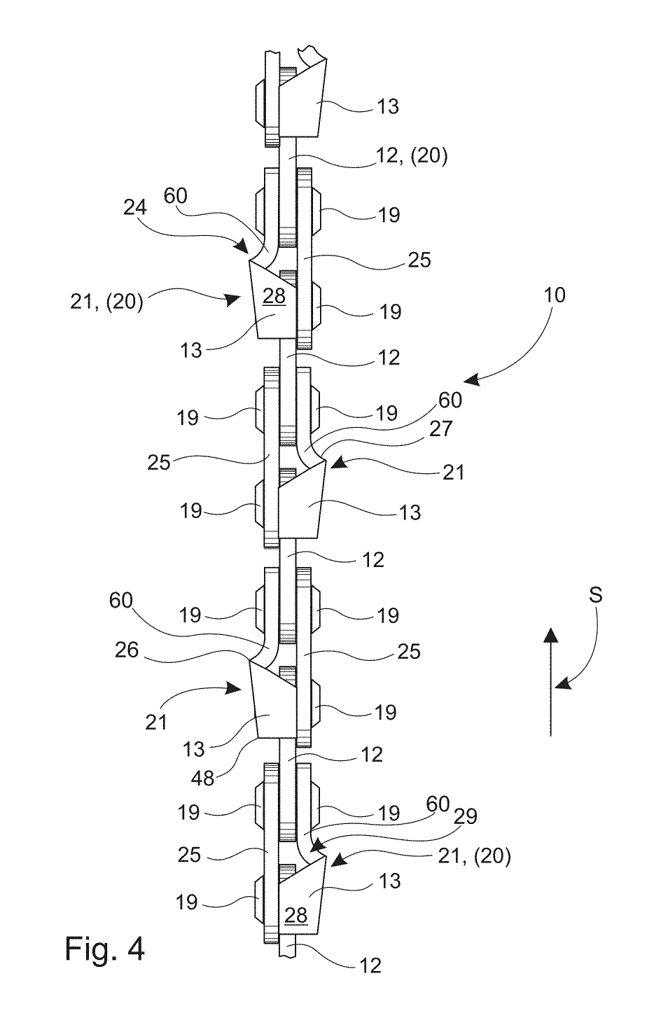

According to FIG. 4, the cutting edge 24 includes, for its part, following an as such known principle, a cutting corner 26 arranged in its upper corner on the side of the depth-adjustment tooth 15, and the side plate 27 of the tooth link 21. The cutting corner 26 and side plate 27 of the tooth link 21 cut the tree's 18 fibres by cutting the tree 18 by slicing i.e. chipping. In addition, the cutting tooth 13 also includes a smooth shaping, the cutting corner 29, arranged in its upper plate 28. This guides the chip cut from the tree 18 away from the sawing groove formed in the tree 18 and at the same time also away from contact with the saw chain 10. Thus, the cutting corner 29 lifts the cut wood chips up and out of the sawing gap. There are holes in the cutting tooth 13 and side plate 25 for the rivets 19. By these the tooth link 21, formed by the cutting tooth 13 and side plate 25, is attached to the preceding and following links 20 in the direction of rotation S of the saw chain 10. Through the invention, as empty link intervals have been even entirely eliminated from the tooth links in the saw chain 10, the saw chain 10 needs to avoid to a lesser extent in the saw groove the tree being sawn. In other words, due to increased tooth link density of the saw chain, the tooth links of the saw chain no longer have the possibility to avoid the wood, because the saw chain 10 is operationally stiffer in the sawing situation. Because the tooth links 21 follow each other more closely in the saw chain 10 than in known chains, when the tooth links 21 are in the sawing groove they more effectively prevent it from avoiding.

The drive links 12 belonging to the links 20 can be fitted to the opposite side of the saw chain 10 relative to the side of the adjustment tooth 15 and cutting edge 24 of the cutting tooth 13, in the groove 22 in the guide bar 11. Thus, by using the drive links 12, the saw chain 10 can be fitted into the groove 22 in the guide bar 11, where it circulates the guide bar 11 in the direction of rotation S. The drive links 12 include drive tongues 23 on one edge, being the opposite side, i.e. the side of the inner circumference, of the saw chain 10 to the cutting edge 24 and optional depth-adjustment tooth 15. The drive tongues 23 fit into the groove 22 in the guide bar 11. In addition, the drive tongues 23 are shaped to also suit the shape of the outer circumference of the drive and sprockets 16, 17. In addition to the drive tongues 23, there are holes in the drive links 12 for rivets 19. The drive link 12 is attached by these to the preceding and following links 20 to the tooth links 21. The parts of the tooth link 21, the cutting tooth 13 and side plate 25, lie on each side of the drive link 12 at the rivet holes, to connect the links 20 to each other in a pivoted manner, i.e. rotatably.

In the saw chain 10, several tooth links 21 are arranged consecutively to each other. Thus the saw chain 10 has one or more sections tooth links 21 immediately on both sides of the drive link 12, in the direction of rotation S of the saw chain 10. In the case according to the presented embodiment, every second link 20 of the saw chain 10 is a tooth link 21 and every other a drive link 12. Thus in the saw chain 10, a tooth link 21 and a drive link 12 are arranged to alternate as links 20 over the entire length of the saw chain 10 and thus also over the entire chain loop. Thus, the number of tooth links 21 in the saw chain 10 is double that in a saw chain 10′ according to the prior art.

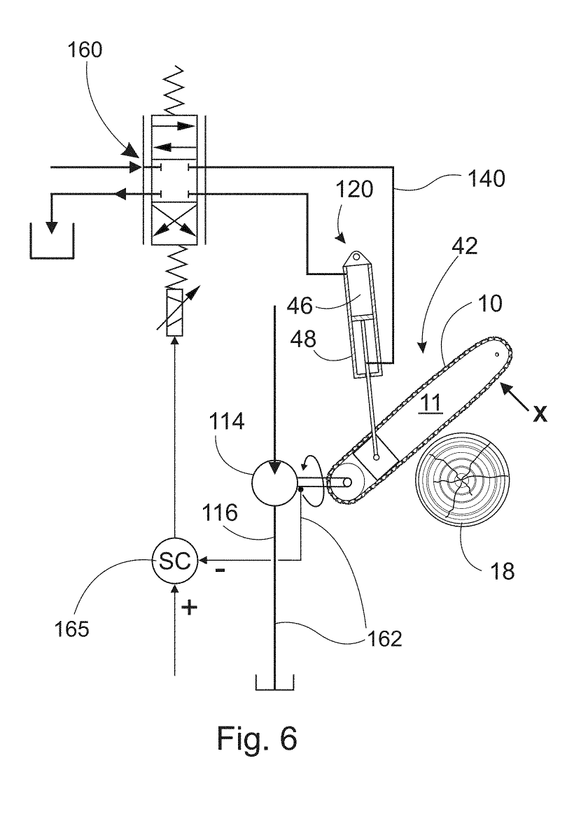

It can be seen from FIG. 3b that, when starting cutting, the use of such a link arrangement significantly limits the entry of the tree 18′ intended to be cut by sawing to the base of the saw chain 10, i.e. to the level of the outer edge of the lower side plates 25, as happens in the case of the intermediate links 14 formed from only side plates 25 (FIG. 6). Thus, this avoids the biting of the cutting tooth 13 too deeply, which stresses the saw chain 10 and is typically precisely what breaks the saw chain 10. In other words, by removing the intervals free of tooth links, i.e. the intermediate links 14 formed only from side plates 25, the travel of the tree 18 against the saw chain 10 is evened. Thus the tree 18 travels in a straighter line, i.e. more evenly against the outer circumference of the chain loop formed by the saw chain 10. Thus, owing to the invention, the saw chain 10 has no links at all formed from only side plates 25. This avoids chipping of the tree 18 that takes place too deeply on the cutting edge 24 of the cutting tooth 13. In this way, the cutting tooth 13 cannot have an excessive cutting depth Hₘₐₓ. On account of this, large point loads are not directed to the saw chain 10. Correspondingly, the saw chain 10 places smaller surface pressures on the guide bar 11.

In consecutive tooth links 21, the cutting teeth 13 are arranged to cut on opposite sides to each other, i.e. to be in opposite directions. A cutting teeth 13 can then be said to be alternately right-handed and left-handed. Further in other words, the consecutive cutting teeth 13 of the saw chain 10 are arranged to alternate to the right and left sides relative to the plane defined by the guide bar 11. First of all this ensures that the sawing groove formed by the saw chain 10 in the tree 18 becomes straight. In addition to this, it has been observed surprisingly in pilot-stage tests, that in this way, as also more generally by arranging cutting teeth 13 in each link, the avoidance due to the sawing force appearing in the sawing situation in the saw chain 10 is also reduced.

In the applicant's pilot-stage tests, measurements have been made of the dynamic widths of various saw chains. Here the term dynamic width of the saw chain refers to the width of the sawing groove made by the saw chain. Due to the cutting forces, the cutting teeth of the saw chain then seek to avoid the wood in the sawing groove and the width of the sawing groove is not the same as the theoretical width of the saw chain. Using a saw chain 10′ known from the prior art a dynamic width of 8.4+0.2 mm was obtained with a new saw chain and correspondingly 7.9+0.2 mm with a slightly-used saw chain. The tendency of the cutting teeth 13 of the saw chain 10′ to avoid the wood 18 being cut was noted to be the greater, the blunter the cutting tooth 13 of the tooth link 21. For its part, using a saw chain 10 according to the invention the dynamic width of the saw chain 10 was as much as 9.2+0.2 mm. The intermediate links 14 formed of only side plates 25 in the saw chain 10′ known from the prior art permitted a greater deformation in the saw chain 10′. This results, in known saw chains 10′, in the cutting teeth 13 seeking to avoid the wood in the sawing groove and thus the sawing groove becoming narrower. In the measurements, the width of the guide bar 11 was 6.3 mm.

The theoretical sawing groove of the saw chains 10′, 10 is 10+0.2 mm. On the basis of the mechanical measurements made by the applicant for the saw chains 10, 10′, the saw chain 10, 10′ narrows in sawing due to its avoidance property by about 0.4 mm for every rivet 19 i.e. pivot. Thus the saw chain 10 according to the invention narrows about 0.8 mm between consecutive cutting teeth 13. For its part, a saw chain 10′ known from the prior art narrows correspondingly about 1.6 mm due to the four rivets 19, i.e. pivots, between the consecutive cutting teeth 13. In addition, it was noted that, if the cutting teeth 13 bite too much, the sawing groove can also widen by a corresponding amount for each pivot, so that the saw chain makes the sawing groove too wide.

The invention also increases the service life of the guide bar 11 and reduces its need for maintenance. As, through the invention, the cutting teeth 13 cannot avoid the wood 18 so much being sawn during sawing, the saw chain 10 cannot twist, i.e. tilt, as greatly as in the case of a saw chain 10′ according to the prior art. Thus also the travel of the saw chain 10 in the guide bar 11 is straighter. Thus, the support of the saw chain 10 takes place, instead of in the groove 22 of the guide bar 11, in the sawing groove using the cutting teeth 13 of the saw chain 10, particularly their sides, against the wood being sawn. Thanks to the densely arranged cutting teeth 13 of the saw chain 10, the support of the saw chain 10 comes more from the consecutive cutting teeth 13 supported in the sawing grove than from the groove 22 in the guide bar 11. In turn, this results in the guide bar 11 and especially the groove 22 in it not wearing as much as happens with saw chains 10′ according to the prior art, in which the saw chain 10′ is able to twist and rotate in the groove 22 in the guide bar 11. Through the saw chain 10 according to the invention, the guide bar 11 has in this case a longer life. In addition, as a result of the reduced twisting and rotation the saw chain 10 according to the invention also remains better in place on top of the guide bar 11.

Point X beneath the point of the flange is marked in FIG. 6. A guide bar equipped with a conventional saw chain wears at this point significantly. This is due to the inertia force of the saw chain after rotating around the end. The saw chain according to the invention reduces this phenomenon significantly, because the consecutive tooth links limit each other's rotation. The phenomenon can be further limited by limiting the cutting tooth's height to 40-65% of the height of the cutting tooth.

The enlarged sawing groove resulting from the saw chain 10 according to the invention permits the narrowing of the physical construction of the saw chain 10. According to one embodiment, the width of the saw chain 10 can be, for example, 10-40%, preferably 15-30% greater than the width of the guide bar 11. Here the width of the saw chain 10 can refer to the distance between the cutting corners 26 of the cutting teeth 13 cutting on opposite sides. The saw chain 10 can be implemented with the parts of the saw chain narrowed by, for example, 1.6 mm. The construction, which is narrower relative to known saw chains, in turn means that the power required to drive the saw chain 10 (to rotate it around the guide bar 11 can be reduced).

The applicant has observed in pilot-stage tests that only in the middle stage of sawing large trees with a diameter of more than 30 cm, i.e. in the case of the sawing point of the greatest diameter, the sawdust leaving the sawing groove may block the saw chain 10. At this point this limits the cutting speed. But as sawing progresses from this, and the diameter of the sawing point again diminishes, i.e. in the final stage of cutting, the cutting speed again increases. Thus, the tree 18 is not able to split.

In addition to the saw chain 10, the invention equally relates to a tree-handling device 40, of which an example is shown above in FIG. 2. The tree-handling device 40 includes gripping means 41 for gripping the tree 18 for cutting, and a cutting device 42. The cutting device 42 includes a guide bar 11 equipped with a groove 22. A saw chain 10 is arranged to rotate in the groove 22 in order to cut the tree 18. In addition, the guide bar 11 is arranged to rotate to perform sawing.

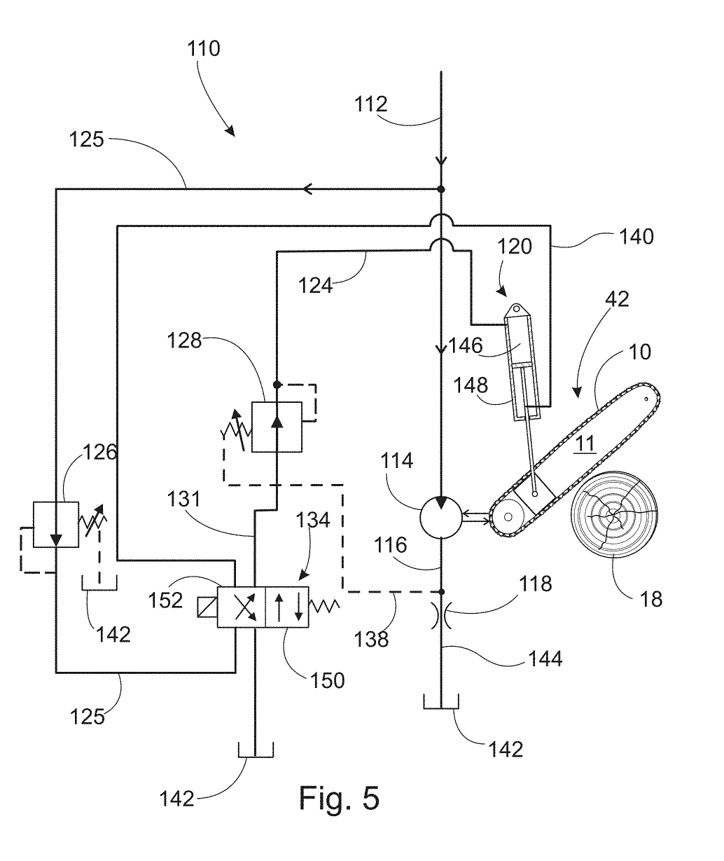

The control of the cutting device 42 can be advantageously implemented using the method according to Finnish patent number 123055 (U.S. Pat. No. 9,669,562 B2) (FIGS. 1 and 5). At present, the control operating in the simplest way is based on a throttle 118 installed in the return line of the motor 114 of the drive wheel 16. When the drive wheel's 16 motor 114 is running, pressure, which affects the feed, is obtained with the aid of the throttle for the hydraulic cylinder 120 (rotation means) intended for the feed, i.e. the rotation of the guide bar 11. The greater the speed of the drive wheel's 16 motor 114, the greater is the feed pressure affecting the rotation of the guide bar 11, i.e. the loading of the guide bar 11 against the tree 18. When the drive wheel's 16 motor 114 slows, the hydraulic pressure drops. The hydraulic arrangement is very rapid, due to the non-compressibility of the liquid.

In FIG. 5, the hydraulic arrangement 110 includes a cutting device 42, a hydraulic feed line 112, a hydraulic motor 114 for rotating the saw chain 10 of the cutting device 42, a return line 144 from the hydraulic motor 114 to the tank 142, and a throttle 118 for throttling the flow leaving the hydraulic motor 114 in the return line 116. Further, the hydraulic arrangement 110 includes a hydraulic operating device 120 for pressing the guide bar 11 of the cutting device 42 against the tree 18 being cut, the feed line 125 of the hydraulic operating device 120 connected in parallel with the hydraulic motor 114 on the feed line 112, and a pressure-reduction valve 126 installed on the feed line 125 of the hydraulic operating device 120. In addition to this, the hydraulic arrangement 110 further includes a pressure valve 128 between the return line 124 of the hydraulic operating device 120 and the return line 116 of the hydraulic motor 114, in order to control the hydraulic operating device 120 on the basis of the operating speed of the hydraulic motor 114.

With the aid of a directional control valve 134, the cylinder 120 of the cutting device 42 is controlled, by which the cutting disc 11 is raised and lowered. The directional control valve 134 can be, for example, a 2/2 valve, in which one position is the direct flow position 150 and the other position the cross-flow position 152.

When there is no flow in the directional control valve 134, and the directional control valve is in the direct flow position 150, the oil is guided to the lower end 148 of the cylinder 120 through line 140 and the cutting flange 11 tends to rise up from the tree 18. When the position of the directional control valve 134 changes to the cross-flow position 152, a pressure of about 50 bar can affect the pressure valve 128 through the intermediate line 131. The same pressure also affects the upper end 146 of the cylinder 120 with the aid of the pressure line 124 and presses the cutting saw 42 against the tree 18 with the aid of the cylinder 120. The adjustment value of the pressure valve 128 can be, for example, about 25 bar, depending on the pressure level available in the arrangement. However, the pressure tends to discharge to the oil tank 142 through the throttle 118 through the pressure valve 128 and the control line 138.

The same control curve can naturally be implemented electronically and using software. The flow data is then collected using a suitable sensor. Using the sensor's data, the software means in turn regulate the pressure of the guide bar's 11 pressing cylinder. Naturally, a variable corresponding to the speed of the chain, for example, the rotational velocity of the motor, can be measured and can be implemented electronically, FIG. 6, when a throttle will not be needed in the outlet line 116. The motor's 114 rotational velocity is measured using a sensor 162, the data being led to a controller 165. This controls a proportion valve 160, which operated the hydraulic operating device 120. The electronic adjustment must be rapid, with a response time of 1-100 ms, preferably 10-50 ms. Software implementations can be too slow, unless attention is paid to the matter. The chain travels 3 cm in 100 ms, if the speed is 30 m/s. As a rule of thumb it can be said that the reaction of the chain should be rapid over a distance of two cm.

In measurements of the saw chain 10 carried out in pilot-stage tests it has been shown that the weight of the saw chain 10 according to the invention increases by about 10%. Now, when the saw chain's 10 cutting capacity is about 100% greater with small trees and also in the final stage of cutting large trees, the speed of the saw chain 10 can be reduced. A reduction of speed by, for example, one half permits a cutting speed near to the previous one, but the kinetic energy of the saw chain 10 drops by about 70%. If the speed is reduced by only 30% of the original speed of the saw chain, in the case of a saw chain 10 according to the invention kinetic energy is created that is only about 60% relative to a known saw chain 10′.

Because the saw chain 10 saws more efficiently at a lower speed, with the toothing according to the invention a greater tensile stress is imposed on the saw chain 10. As an example, sawing at a speed of 30 m/s requires a power of about 30 kW, i.e. a tensile force of 1000 N acts of the saw chain. This is only about 10% of the ultimate load of the saw chain, so this force is not decisive. The saw chain 10 according to the invention for its part also permits a lightening of the equipment of a multi-process machine. In principle, for example, a 70-kW engine can be replaced with a smaller and lighter 40-kW engine. In addition to the smaller engine, the lightening benefit is also repeated, for example, in the size of the pressure-medium lines and control blocks required.

The speed of the saw chain 10 when cutting a tree 18 is arranged to be 20-35 m/s, 20-33 m/s, 20-30 m/s, or even more preferably 25-33 m/s. 30 m/s can be given as a specific example of the speed. In solutions according to the prior art, the speed of the saw chain 10′ can be 40 m/s. Due to the lower speed of the saw chain 10 relative to the prior art, lubricating medium also stays better in the saw chain 10. The lubrication of the sprocket 17 also improves as its speed is lower. All of this increases the life of the guide bar 11, the sprocket 17, and the saw chain 10. In addition, at a lower speed saw motors with a higher torque can be used to drive the saw chain 10 according to the invention, compared to saw chains 10′ known from the prior art. When the chain speed is reduced, the creation of dangerous chain-bullets also diminishes considerably and the safety of sawing improves.

Low-revolution saw motors are more durable and other versions too can be use as motors. 14-cc (cm³/r) motors were used in the pilot-stage tests, but even greater efficiency can be achieved with a 19-cc (cm³/r) motor. According to one embodiment, the length of the guide bar 11 can be, for example, 30-100 cm. According to one embodiment, the power of the hydraulic saw motor 54 can be, for example, 20-100 kW. The power range can be divided into groups. The length of the guide bar 11 correlates with the power ranges formed in groups in a set manner. Surplus power can be, for example, 50%, if more rapid cutting is required.

The saw chain 10 is formed from a saw-chain blank 100 by cutting a suitably dimensioned blade-chain portion from it for the length of the guide bar 11, in which the tooth links 21 of the opposite ends cut on opposite sides to each other. The opposite ends of the saw-chain blank 100 are then joined together using a connector element 19′, in such a way that one drive link 12 comes between the consecutive tooth links 21 at the ends to be joined together. Thus an endless chain loop forming an installation-ready saw chain 10 is obtained, which can be installed in the groove 22 arranged for it around the guide bar 11 of the cutting device 42, travelling via the drive wheel 16 belonging to the cutting device 42.

The invention also further relates to a method for arranging the cutting operation of a timber-process device 40. In the method, the tree 18 is gripped before cutting it. Gripping can be performed using the gripping means 41 of the tree-handling device 40, such as, for example grab claws 50. After gripping, the tree 18 is cut by sawing with the saw chain 10. During sawing, the saw chain 10 is circulated by the drive wheel 16 in the groove 22 arranged in the guide bar 11 of the cutting device 42. The saw chain 10 includes links 20 joined to each other by connector elements 19′, so that the saw chain 10 is an endless chain loop. As links 20, the saw chain 10 includes tooth links 21 and drive links 12. The tree 18 is cut by sawing, using the tooth links 21.

In the method, the travel of the saw chain 10 against the tree 18 is evened by two or more tooth links 21 arranged consecutively in the saw chain 10. In addition, in the method the saw chain 10 is also rotated during cutting at a speed of 20-35 m/s, or even more preferably 25-33 m/s. These advantages have been already stated above in the application's description.

According to yet another embodiment, in the method, during the cutting of the tree 18, the saw chain 10 is rotated around the guide bar 11 by a drive device (drive wheel 16, hydraulic motor 54) and the guide bar 11 is rotated by an operating device against the tree 18 being cut. The rotation of the guide bar 11 takes place relative to a pivot point arranged in one end of it. The rotation of the guide bar 11 against the tree 18 being cut is controlled on the basis of the speed of the saw chain 10 or a comparable variable. As stated above, the speed of the saw chain 10 according to the invention can vary in different stages of the cutting. At the start and end of the cutting, the saw chain's 10 speed can be higher, and be lower in the middle of the cutting, when the diameter of the object being cut is greatest. By adjusting the loading of the guide bar 11 against the tree 18 on the basis of this speed data, the speed of the saw chain 10 can be affected and thus sawing accelerated. When the saw chain's 10 speed drops, the loading of the guide bar 11 can be correspondingly reduced. When the saw chain's 10 speed is high, the loading of the guide bar 11 can also be kept high.

The saw chain 10 according to the invention is also suitable for cutting very small trees. In a conventional saw chain 10′ the cutting-tooth interval is about 40 mm, whereas in the saw chain 10 according to the invention it is about 20 mm. At the start of sawing the small branches have less chance of striking the body part of the saw chain 10, i.e. the level of the edge of intermediate links 14 formed of only side plates 25, as these are not in the saw chain 10. Such a situation very typically occurs during felling cutting. Though the tree to be felled might be large, there are often branches in its butt area and before the saw chain 10 starts moving a branch or twig can become lodged at an intermediate link 14 in a known saw chain 10′ where there is no cutting tooth 13. Due to the great length of the working boom, the driver cannot see precisely the point in the tree where cutting will take place.

The construction according to the invention is suitable, for example, for saw chains 10, whose pitch is 10-20 mm (FIG. 3b). For example, in the saw chains 10′, 10 of FIG. 3a the pitch is about 10 mm. The width of the saw chain 10 can be, for example, 7+0.2 mm at the rivets 19 and 5.5+0.2 mm at the cutting tooth 13 and the side plate 25. The cutting tooth 13 too, especially its upper plate 28, can be narrowed. The cutting tooth 13 can be narrowed starting from its upper corner 26 to the rear edge 48 of the trailing edge of the upper plate 28. This narrows the width of the saw chain 10 compared to a known chain.

The bite of the cutting tooth 13 can also be reduced through the invention. The bite can be reduced compared to saw chains 10′ according to the prior art, in which the angle between the surface of the upper plate 28 of the cutting tooth 13 and the horizontal plane is, for example, about 9 degrees. In the saw chain 10 according to the invention, this angle can be surprisingly substantially smaller than in the known chain. An example of this angle is 0.5-7 degrees, 0.5-6 degrees, more especially 0.7-6 degrees, 0.7-5 degrees, and further, as various specific examples, 7 degrees, 6 degrees, 5 degrees, 4 degrees, 3 degrees, 2 degrees, 1 degree, preferably 1-5 degrees. The small bite angle gives plenty of space for the chips created during sawing, which becomes less thick than in the prior art, due to the smaller bite angle.

In FIGS. 3a, 3b, and 4, a small gap can be seen between the consecutive links 20. However, the consecutive tooth links 21 can even touch each other, when the saw chain 10 is examined over its straight run. The depth-adjustment tooth 15 of the next link 20 performing the depth adjustment in the consecutive links 20 is then situated at the rear edge of the cutting tooth 13 of the previous link 20. The durability of the saw chain 10 thus improves and thus the thickness of the windshield 38 of the multi-process machine 31, or other similar machine, can be, for example, only 10-25 mm, because the risk of the saw chain 10 breaking is reduced. The thickness of the windshield is often increased for other reasons too than the chain bullet problem.

With reference to FIG. 3a, the space 59 between the consecutive cutting teeth 13 can be at least half free of structures in the direction of the height H of the cutting tooth 13. In that case, the height of the depth-adjustment tooth 15, or the corresponding formation 15′ at the same location, is less than 50% of the height H of the cutting tooth 13. Preferably the height of the depth-adjustment tooth 15 or the formation 15′, which is, for example, at a corresponding location to it, is less than 20% of the height H of the cutting tooth 13, but, however, under 50% of the height H of the cutting tooth 13. In other words, for example the height of the depth-adjustment tooth 15 can be 0-50% of the height H of the cutting tooth 13. Through this, the height H of the space 59 (determined by the outer edge of the formation 15′) between the consecutive cutting teeth 13 is more than 50% of the height H of the cutting tooth 13. Here, the height H of the cutting tooth 13 is the distance from the base of the saw chain 10, i.e. from the base 60 of the cutting tooth 13 to the cutting edge 24 of the cutting tooth 13. The base 60 of the cutting tooth 13 corresponds mainly to the outer edge of the side plate 25. Correspondingly, the depth Hₛ of the space 59 is the (vertical) distance from the upper edge of the formation 15′ (if there is one) to the cutting edge 24 of the cutting tooth 13.

Thanks to the consecutive cutting teeth 13, i.e. without intermediate links, the cutting depth H of the cutting teeth can be maintained by the cutting teeth 13 themselves. The reduced bite angle also assists in this. This simplifies the construction of the saw chain 10 and also facilitates its maintenance (for example, there is no need to adjust the height of the depth-adjustment tooth).

With reference to FIG. 7, it can be stated that the empty space is arranged for the sharpening means in front of the cutting tooth 13 as 70-130% of the interval to the rear edge of the next cutting tooth. In the figure, the saw chain is in the flange 11′ of the sharpening device, which sharpening device includes a suitable pulse feeder (not shown), for always bringing the next cutting tooth to be worked on. Here, the sharpening disc is at an angle of 37 degrees and its thickness is 80% of the interval dimension. Thus larger sharpening machines than previously can be used.

In pilot-stage tests of the saw chain 10 according to the invention, the significant advantage has also been observed that the need for post-tensioning the saw chain 10 is clearly less than that of a saw chain 10′ known from the prior art. Thus clearing can be performed with the same saw chain 10 for even a whole day, without post-tensioning of the saw chain 10. This is a result of the lower stress, of the even loading, of the more even wear in the guide bar, and also of the reduced vibration, which is a problem in known saw chains 10′, in the saw chain according to the invention. Due to this, the saw chain 10 works well even in felling heads without an automatic chain tensioner. In these, the chain tensioner accounts for a relatively significant portion, of even thousands of Euros, of the total price of the felling head, so that savings are gained when investing in a felling head.

In addition, it has also been observed in pilot-stage tests that the saw cut of the saw chain 10 has a considerably smoother surface compared to the known technique. This positively affects, for example, colour markings made on sawn surfaces. Due to the surface smoothness they also adhere better to the wood and are clearer, making them also highly visible.

Above, the effect of the chain-bullet phenomenon was dealt with from the driver's point of view. The same phenomenon also endangers people in the vicinity. The hazard area around the work machine can be reduced by using the invention.

The invention has been tried in harvesters manufactured by Kone Ketonen Oy. The chains were manufactured from “STIHL® Moto Chain” chains (groove widths 1.6 mm and 2.0 mm) marketed by Uittokalusto Oy (FI). The STIHL® chains were disassembled into components and reassembled again without the intermediate links between the tooth links 21. In some tests, the adjustment teeth were removed from the tooth links, which proved to be very beneficial. The saw chain 10 according to the invention can be applied, in addition to the embodiment described above, in any other industrial sawing application whatever, except in hand tools, without additional intermediate links between the cutting links.

It should be understood that the above description and the related figures are intended only to illustrate the device and method according to the present invention. The invention is thus not restricted to the embodiments described above or defined in the Claims, but instead many different variations and adaptations of the invention, which are possible within the scope of the inventive idea defined in the accompanying Claims, will be obvious to one skilled in the art.

1-15. (canceled)

16. A saw chain for a cutting device of a tree-handling device, comprising:
links connected by connection elements to each other, in such a way that the saw chain is an endless chain loop, which is arranged to circulate in a groove arranged in a guide bar,
wherein the links comprise tooth links and drive links which alternate in such a way that several tooth links are arranged consecutively, connected together by drive links,
and in which the tooth links comprises a cutting tooth having an upper plate, and in which cutting tooth there is a cutting edge arranged on one side of the saw chain comprising a cutting corner arranged in an upper corner of the cutting edge, and a side plate of the tooth link, and a bite angle of the cutting tooth is 0.5-6 degrees,
and in which the cutting teeth in the consecutive tooth links are arranged to cut on opposite sides relative to each other,
and in front of which cutting tooth there is an empty space to the following tooth link, that is, of 80-100% of the height of the cutting tooth, when the height of an optional depth-adjustment tooth will be 0-20% of the height of the cutting tooth,
and in which the drive links can be fitted in the groove of the guide bar, on the opposite side of the saw chain.

17. The saw chain according to claim 16, wherein the bite angle of the cutting tooth is 0.5-5 degrees.

18. The saw chain according to claim 16, wherein the height of the cutting tooth is 40-65% of the length between the connector elements, i.e. of the interval dimension.

19. The saw chain according to claim 16, wherein the width of the saw chain is 10-40% greater than the width of the guide bar.

20. The saw chain according to claim 16, wherein the width of the saw chain is 15-30% greater than the width of the guide bar.

21. The saw chain according to claim 16, wherein an empty space is arranged for the sharpening means in front of the cutting tooth to the rear edge of the following cutting tooth to 70-130% of the interval dimension.

22. A tree-handling device, comprising
gripping means to grip a tree before cutting,
a cutting device, comprising a rotatable guide bar equipped with a groove, in which the saw chain is arranged to circulate to cut the tree,
and which saw chain comprises
links connected to each other by connector elements, in such a way that the saw chain is an endless chain loop,
wherein the links comprise tooth links and drive links which alternate in such a way that several tooth links are arranged consecutively, connected together by drive links,
and in which the tooth links comprises a cutting tooth having an upper plate, and in which cutting tooth there is a cutting edge arranged on one side of the saw chain comprising a cutting corner arranged in an upper corner of the cutting edge, and a side plate of the tooth link, and a bite angle of the cutting tooth is 0.5-6 degrees,
and in which the cutting teeth in the consecutive tooth links are arranged to cut on opposite sides relative to each other,
and in front of each cutting tooth there is an empty space to the next tooth link, that is, of 80-100% of the height of the cutting tooth, when the height of an optional depth-adjustment tooth is 0-20% of the height of the cutting tooth,
and which the drive links are arranged in the groove of the guide bar on opposite sides of the saw chain.

23. The tree-handling device according to claim 22, wherein a bite angle of the cutting tooth is 0.5-5 degrees.

24. The tree-handling device according to claim 22, wherein the speed of the saw chain when cutting the tree is arranged to be 20-35 m/s.

25. The tree-handling device according to claim 22, wherein the speed of the saw chain when cutting the tree is arranged to be 25-33 m/s.

26. The tree-handling device according to claim 22, further comprising a cab comprising a windshield with a thickness of 10-25 mm.

27. The tree-handling device according to claim 22, wherein the height of the cutting tooth is 40-65% of the length between the connector elements, i.e of the interval dimension.

28. The tree-handling device according to claim 22, wherein the width of the saw chain is 10-40% greater than the width of the guide bar.

29. The tree-handling device according to claim 22, wherein an empty space is arranged for the sharpening means in front of the cutting tooth to the rear edge of the following cutting tooth to 70-130% of the interval dimension.

30. A saw-chain blank, which is arranged to form a saw chain as an endless chain loop, for the cutting device of a tree-handling device, which saw-chain blank comprising
links connected to each other by connector elements,
wherein the links comprise drive links and tooth links arranged in such a way that several consecutive tooth links are fitted to the saw-chain blank connected together by drive links, and which tooth links comprise a cutting tooth, in which there is an upper plate and a cutting edge fitted to one side of the saw-chain blank, and which cutting edge comprising
a cutting corner arranged in an upper corner of the cutting edge, and a side plate of the tooth link, and a bite angle of the cutting tooth is 0.5-6 degrees,
and in which the cutting teeth in the consecutive tooth links are arranged to cut on opposite sides relative to each other, and in each tooth link there is an empty space up to the next tooth link, in front of the cutting tooth that is, of 80-100% of the height of the cutting tooth, when the height of an optional depth-adjustment tooth will be 0-20% of the height of the cutting tooth, and from which saw-chain blank can be formed the said saw chain, which is an endless chain loop, and which can be arranged to be circulated by the drive links in a groove arranged in a guide bar belonging to the cutting device.

31. A saw-chain blank according to claim 30, wherein a bite angle of the cutting tooth is 0.5-5 degrees.

32. A method for arranging the cutting operation of a tree-handling device, the method comprising the steps of
gripping a tree prior to cutting,
cutting the tree with a saw chain circulating in a groove arranged in a rotatable guide bar, and which saw chain comprising
links connected to each other by connector elements, in such a way that the saw chain is an endless chain loop,
wherein the links comprise tooth links, to cut the fibres of the tree, which tooth links comprise a cutting tooth and a cutting edge, and drive links on the opposite side of the saw chain in the groove in the guide bar,
comprising the further steps of
using a saw chain according to claim 16, and
circulating the saw chain in cutting at a speed of 20-35 m/s.

33. The method according to claim 32, wherein circulating the saw chain in cutting at a speed of 25-33 m/s.

34. The method according to claim 32, comprising in connection with cutting the further steps of
circulating the saw chain around the guide bar by a drive device,
pressing the guide bar against the tree to be cut
controlling pressing using a rapid adjustment with a response time of 1-100 ms, which measures a variable proportional to the speed of the saw chain.

35. A multi-process machine, comprising
a motorized base machine,
a cab fitted to the base machine and equipped with a windshield,
a crane, equipped with a set of working booms, fitted to the base machine,
a tree-handling device, fitted to the end of the set of working booms, comprising
gripping means to grip the tree before cutting,
a cutting device using a saw chain, comprising a guide bar, rotatable using an operating device, and a rotation motor for the saw chain, and in which the saw chain is arranged to circulate around the guide bar, to cut the tree,
wherein the saw chain is according to claim 16 and the cutting device comprising a rapid control device with a response of 1-100 ms arranged to detect a variable proportional to the speed of the saw chain and to control the operating device operating the guide bar.

36. The multi-process machine according to claim 35, wherein the control device comprises a hydraulic connection to detect the rotational velocity of the motor and to control the operating device formed from it.
